(19) United States
(12) Patent Application Publication
(10) Pub. No.: US 2025/0048051 A1
(43) Pub. Date: Feb. 6, 2025

(54) A METHOD OF PROCESSING AUDIO FOR PLAYBACK OF IMMERSIVE AUDIO

(71) Applicants: Dolby Laboratories Licensing Corporation, San Francisco, CA (US); DOLBY INTERNATIONAL AB, Dublin (IE)

(72) Inventors: C. Phillip BROWN, Castro Valley, CA (US); Eytan RUBIN, Nuremberg (DE); Jacobo GIRALT, Nuremberg (DE); Michal Stanislaw RYBCZYNSKI, Wroclaw (PL); Thomas ZIEGLER, Nuremberg (DE)

(73) Assignees: Dolby Laboratories Licensing Corporation, San Francisco, CA (US); DOLBY INTERNATIONAL AB, Dublin (IE)

(21) Appl. No.: 18/721,850

(22) PCT Filed: Dec. 19, 2022
(86) PCT No.: PCT/US2022/081955

§ 371 Date: Jun. 19, 2024

Related U.S. Application Data
(60) Provisional application No. 63/353,778, filed on Jun. 20, 2022.
(60) Provisional application No. 63/291,598, filed on Dec. 20, 2021.

(30) Foreign Application Priority Data
Jun. 20, 2022 (EP) 22179943.0

(51) Int. Cl. H04S 7/00; H04S 5/00

(52) U.S. Cl. CPC H04S 7/302; H04S 5/00

(57) ABSTRACT

A method (1000) of generating a plurality of audio channels from audio containing height and non-height audio channels for playing back them with an immersive loudspeaker system of with at least one height loudspeaker (5) inside a listening environment, comprising: applying (1500) a virtual height filter (1300) to a portion of each height channel (1010) for, when playing back the height channel by one of the loudspeakers, attenuating spectral components of the height channel directly emanating from said loudspeaker (1;2;3;4) and for amplifying spectral components of the height channel reflected from a roof or an area close to the roof inside the listening environment, to generate a plurality of virtual height filtered audio signals which are added to the corresponding non-height audio channels for playback by corresponding loudspeakers; and playing back the remaining portions of each height audio channel with the at least one height loudspeaker (5).

### CROSS-REFERENCE TO RELATED APPLICATION

This application claims priority of the following priority application: U.S. provisional application 63/291,598 (reference: D21147AUSP1), filed 20-12-2021, U.S. provisional application 63/353,778 (reference: D21147AUSP2), filed 20-6-2022 and EP application EP22179943.0 (reference: D21147AEP), filed 20-6-2022.

### TECHNICAL FIELD

This disclosure relates to the field of audio processing. In particular, the disclosure relates to a method of generating at least two audio channels from audio in an immersive audio format comprising a plurality of front and rear height audio channels and a plurality of front and rear non-height audio channels for playback the plurality of audio channels with an immersive loudspeaker system. The disclosure further relates to an apparatus comprising a processor configured to carry out the method, to a vehicle comprising the apparatus, to a program and a computer-readable storage medium.

### BACKGROUND

Vehicles usually contain loudspeaker systems for audio playback. Loudspeaker systems in vehicles may be used to playback audio from, for example, tapes, CDs, audio streaming services or applications executed in an automotive entertainment system of the vehicle or remotely via a device connected to the vehicle. The device may be, e.g., a portable device connected to the vehicle wirelessly or with a cable. For example, most recently, streaming services such as Spotify and Tidal have been integrated into the automotive entertainment system, either directly in the vehicle's hardware (usually known as the “head unit”) or via a smart phone using Bluetooth or Apple CarPlay or Android Auto. The loudspeaker systems in vehicles may also be used to playback terrestrial and/or satellite radio. Conventional loudspeaker systems for vehicles are stereo loudspeakers systems. Stereo loudspeaker systems may include a total of four loudspeakers: a front pair of loudspeakers and a rear pair of loudspeakers, for the front and rear passengers, respectively. However, in more recent years, with the introduction of DVD players in vehicles, surround loudspeaker systems have been introduced in vehicles to support playback of DVD audio format.

Immersive audio is becoming mainstream in cinemas and homes listening environments. With immersive audio becoming mainstream in the cinema and the home, it is natural to assume that immersive audio will be played back also inside vehicles. Dolby Atmos Music is already available via various streaming services. Immersive audio is often differentiated from surround audio format by the inclusion of one or more overhead or height audio channels. Therefore, for playing back immersive audio, overhead or height loudspeakers are used.

FIG. 1 shows an interior view of a vehicle 100. Vehicle 100 includes a loudspeaker system including loudspeakers 10, 11, 30, 31, 41, 42, 43, and 44. The loudspeakers are only shown for the left side of vehicle 100. Except for loudspeakers 10 and 11, corresponding loudspeakers may be arranged symmetrically on the right side of vehicle 100. In particular, the loudspeaker system of FIG. 1 includes: tweeter loudspeakers 41, 42 and 43, a full range front loudspeaker 30 and rear loudspeaker 31, a central loudspeaker 10, a Low Frequency Effects loudspeaker or Subwoofer 11 and a height loudspeaker 44. Tweeter loudspeaker 41 is placed close to the dashboard of the vehicle. Tweeter loudspeaker 42 is placed low on a front side pillar of vehicle 100. However, tweeter loudspeakers 41, 42, 43 but also full range front and rear loudspeakers 30 and 31 may be placed in any position suitable for the specific implementation. Height loudspeaker 44 is placed on the roof of the vehicle, in this example, above the driver seat.

While high end vehicles may contain multiple overhead or height loudspeakers, there are still vehicles which use a limited number of height stereo loudspeakers. In fact, height loudspeakers dramatically increase complexity of the loudspeaker system in the vehicles. The height loudspeaker needs to be placed in the roof of the vehicle which is usually not adapted for this purpose. For example, vehicles have usually a low roof which limits the available height for placement of height loudspeaker. Furthermore, vehicles are often sold with the option to mount a sunroof to uncover a window in the vehicle's roof, making a difficult industrial design challenge to integrate or place many height loudspeakers in the roof. Additional audio cables may also be required for such height loudspeakers. Placement of multiple overhead or height loudspeakers is also a concern when considering safety of the vehicle and the placement of, e.g., airbags, in the same or close location of overhead or height loudspeakers. For all these reasons, integration of multiple height loudspeakers in vehicles may be costly due to space and industrial design constraints. On the other hand, using only a limited number of height loudspeakers dramatically limit the spatial resolution of the sound in the height plane of the vehicle.

### SUMMARY

It would be advantageous to playback immersive audio content in an immersive loudspeaker system with at least one height loudspeaker. In the context of the present disclosure an “immersive loudspeaker system” is a loudspeaker/speaker system that comprises at least one height loudspeaker (e.g. located above a listener's head, i.e. in a so-called height plane) and a plurality of front and rear non-height loudspeakers (e.g. located below the listener's head, i.e. in a so-called base plane).

It would be advantageous to create a perception of sound height with a satisfactory spatial resolution by playing back immersive audio content into an immersive loudspeaker system including at least one height loudspeaker such that the user's audio experience is enhanced even without using more than two overhead loudspeakers.

An aspect of this disclosure provides a method of generating a plurality of audio channels from audio in an immersive format comprising a plurality of front and rear height audio channels and a plurality of front and rear non-height audio channels, for playing back the plurality audio channels with an immersive loudspeaker system comprising at least one height loudspeaker and a plurality of front and rear non-height loudspeakers. The method comprises applying a virtual height filter to a portion of each front and rear height audio channel of the plurality of front and rear height channels. The virtual height filter is configured for, when the at least one of the front and rear heigh audio channels is played back by a corresponding loudspeaker of the front and rear non-height loudspeakers, at least partially attenuating spectral components of the at least one height channel directly emanating from the loudspeaker from which the height channel is played back. The virtual height filter is also configured for at least partially amplifying spectral components of the height channel reflected from a roof or an area close to the roof inside the listening environment, to generate a plurality of front and rear virtual height filtered audio signals. The method further comprises adding each front and rear virtual height filtered audio signal of the plurality of front and rear virtual height filtered audio signals to the corresponding front and rear non-height audio channel of the plurality of front and rear non-height audio channels, to generate added audio signals for playback by the corresponding front or rear non-height loudspeaker. The method further comprises playing back the remaining portion of each front and rear height audio channel of the plurality of front and rear height channels with the at least one height loudspeaker.

In the context of the present disclosure the term “channel” means an audio signal plus optionally metadata in which the position is coded as a channel identifier, e.g., left-front or right-top surround; “channel-based audio” is audio formatted for playback through a pre-defined set of loudspeaker zones with associated nominal locations, e.g., 5.1, 7.1, and so on; the term “object” or “object-based audio” means one or more audio channels with a parametric source description, such as apparent source position (e.g., 3D coordinates), apparent source width, etc.

When the portion of height channel is played back from one of the non-height loudspeakers without filtering, sound may radiate along different paths. Some sound may radiate along a direct path from the non-height loudspeaker to a listening position (e.g., to a passenger's or driver's ears). Some other sound may radiate along a reflected path from the on-height loudspeaker to the listening position. For example, some sound may be reflected from the roof or area close to the roof inside the listening and therefore radiate from the roof or area close to the roof, to the listening position. The sound that radiates along the direct path is undesired when the height channel is played back by the non-height loudspeakers. By applying the virtual height filter to portions of height channel, the spectral components of the portions of the height channels reflected from the roof or the close to the roof are amplified while the spectral components of the portions of height channels directly emanated to the loudspeaker are attenuated. Configured as above the method compensates for the undesired direct sound and introduces perceptual height cues into the audio signal being fed to non-height loudspeakers, thereby improving the positioning and perceived quality of the virtual height signal. For example, a directional hearing model has been developed to create a virtual height filter, which when used to process audio being reproduced by the non-height loudspeakers, improves that perceived quality of the reproduction. In addition, by playing back the remaining portions of height audio channels directly with the at least one height loudspeaker a desired balance of the front and rear height audio channels among the non-height loudspeakers and the at least one height loudspeaker can be achieved for an improved spatial resolution in the height plane which provides an improved immersive listening experience. The improved spatial resolution in the height plane is achieved by just using a single height loudspeaker or only two height loudspeakers.

In an embodiment, the portion of each of the plurality of front and rear height channels may be a function of one or more of: a location of the at least one height loudspeaker along a length of the listening environment or a desired balance distribution of the plurality of audio channels among the loudspeakers of the immersive loudspeaker system.

In an embodiment, applying the virtual height filter to a portion of each of the plurality of front and rear height audio channels may comprise applying the virtual height filter to a portion of the front height audio channels which is proportional to a location of the at least one height loudspeaker moving away from the front and getting close to the rear of the listening environment.

In an embodiment, applying the virtual height filter to a portion of each of the plurality of front and rear height audio channels may comprise applying the virtual height filter to a portion of the rear height audio channels which is proportional to a location of the at least one height loudspeaker moving away from the rear and getting close to the front of the listening environment.

In an embodiment, playing back the remaining portion of each of the plurality of front and rear height audio channels with the at least one height loudspeaker may comprise playing back a remaining portion of each of the plurality of the front height audio channels which is proportional to a location of the at least one height loudspeaker moving away from the rear and getting close to the front of the listening environment.

In an embodiment, playing back the remaining portion of each of the plurality of front and rear height channels with the at least one height loudspeaker may comprise playing back a remaining portion of each of the plurality of the back channels which is proportional to a location of the at least one height loudspeaker moving away from the front and getting close to the rear of the listening environment.

In an embodiment, the audio in the immersive audio format may further comprise a front right and a front left non-height audio channels, a rear right and a rear left non-height audio channels, a top front right and a top front left height audio channels and a top rear right and a top rear left height audio channels. The front virtual height filtered audio signals may be added to the corresponding front right and front left non-height audio channels. The rear virtual height filtered audio signals may be added to the corresponding rear right and rear left non-height audio channels. These additions generate four added audio signals for playback by corresponding front right and front left, and rear right and rear left non-height loudspeakers.

In an embodiment, the immersive loudspeaker system may comprise a single top (overhead) loudspeaker.

In an embodiment, the remaining portions of the top front right height audio channel, top rear right height audio channel, top front left height audio channel and top rear left height audio channel may be summed up together and playback by the top (overhead) single top loudspeaker.

In an embodiment, the immersive loudspeaker system may comprise two top (overhead) loudspeakers, e.g., a top (overhead) right height loudspeaker and top (overhead) left height loudspeaker.

In an embodiment, the remaining portions of the top front right height audio channel and top rear right height audio channel may be summed up together and played back by top right height loudspeaker. Similarly, the remaining portions of the top front left height audio channel and top rear left height audio channel may be summed up together and played back by the top left height loudspeaker.

In an embodiment, the virtual height filter may have a filter transfer function and wherein the method further comprises determining the filter transfer function of the virtual height filter from one or more parameters identifying the filter transfer function.

In an embodiment, the method may further comprise storing the one or more parameters in a processor as a look-up table or as an analytical function.

In an embodiment, the virtual height filter may have a filter transfer function having a peak at a first frequency and a notch at a second frequency higher than the first frequency.

In an embodiment, at least two of the front and rear non-height loudspeakers may be laterally spaced with respect to a listening position. The method may further comprise determining a filter transfer function for the virtual height filter based on a relative distance of the at the least two loudspeakers from the listening position and on an elevation of the roof or area close to the roof relative to the listening position.

In an embodiment, at least two of the front and rear non-height loudspeakers may be laterally spaced with respect to a listening position. The method may further comprise obtaining a plurality of filter transfer functions for a plurality of virtual height filters based on a range of relative distances of said two non-height loudspeakers from the listening position and on a range of elevations of the roof or area close to the roof relative to the listening position and selecting one filter transfer function from the plurality of filter transfer functions.

In an embodiment, the selected filter transfer function may be the average of the plurality of filter transfer functions.

In an embodiment, selecting one filter transfer function from the plurality of filter transfer functions may comprise selecting one or more parameters identifying the selected filter transfer function based on an average distance of the at the least two loudspeakers from the listening position and based on an average elevation of the roof or area close to the roof relative to the listening position.

In an embodiment, the steps of obtaining, selecting, applying adding and playing back of the method described above may be iteratively applied for each selected filter transfer function until the filter transfer function provides a playback of the at least two channels with maximum perception of sound elevation.

In an embodiment, the method may further comprise applying a gain to the virtual height filter. In an embodiment, the gain may be user configurable.

In an embodiment, the listening environment is a vehicle.

Another aspect of this disclosure provides an apparatus comprising a processor and a memory coupled to the processor, wherein the processor is configured to carry out any of methods described in the present disclosure.

Another aspect of this disclosure provides a vehicle comprising such apparatus.

Other aspects of the present disclosure provide a program comprising instructions that, when executed by a processor, cause the processor to carry out the method of processing audio and further a computer-readable storage medium storing such program.

### BRIEF DESCRIPTION OF THE DRAWINGS

Embodiments of the present disclosure are illustrated by way of example, and not by way of limitation, in the accompanying drawings, wherein like reference numerals refer to similar elements, and in which:

FIG. 1 schematically shows an interior left side view of a vehicle with a loudspeaker system arranged according to an embodiment of the disclosure,

FIG. 2 is a flowchart illustrating an example of a method of generating a plurality of audio channels from audio in an immersive audio format according to an embodiment of the disclosure,

FIG. 3 schematically shows an example of a method of generating a plurality of audio channels from audio in an immersive audio format according to an embodiment of the disclosure,

FIG. 4 schematically shows a top view of a vehicle with a single height loudspeaker,

FIG. 5 schematically shows a top view of a vehicle with a loudspeaker system arranged according to an embodiment of the disclosure,

FIG. 6 schematically shows exemplary paths of sound inside a vehicle,

FIG. 7 schematically shows some examples of a virtual height filter according to some embodiments of the present disclosure,

FIG. 8 schematically shows an example of a method of generating a plurality of audio channels from audio in an immersive audio format according to an embodiment of the disclosure,

FIG. 9 schematically shows a top view of a vehicle with two height loudspeakers,

FIG. 10 schematically shows an example of energy distribution of an immersive loudspeaker system according to an embodiment of the disclosure,

FIG. 11 schematically shows an example of energy distribution of an immersive loudspeaker system according to an embodiment of the disclosure,

FIG. 12 is a schematic illustration of an example of an apparatus for carrying out methods according to embodiments of the disclosure.

### DETAILED DESCRIPTION

Numerous specific details are described below to provide a thorough understanding of the present disclosure. However, the present disclosure may be practiced without these specific details. In addition, well-known parts may be described in less exhaustive detail. The figures are schematic and comprise parts relevant for understanding the present disclosure, whereas other parts may be omitted or merely suggested.

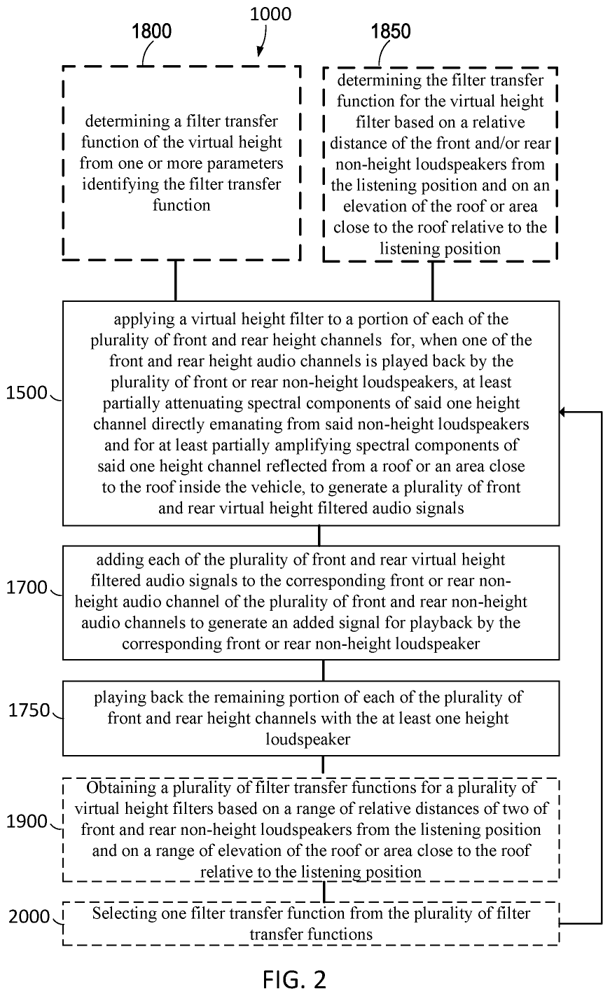

FIG. 2 shows a flowchart illustrating an example of a method 1000 of generating a plurality of audio channels from audio in an immersive audio format (e.g. an immersive bitstream) according to an embodiment of the disclosure. The audio in the immersive audio format comprises a plurality of front and rear height audio channels and a plurality of front and rear non-height audio channels. Method 1000 can be used to playback the generated plurality of audio channels inside a listening environment with an immersive loudspeaker system. The listening environment may be a room, an audio studio, a vehicle or any other closed or partially closed environment suitable to listen audio. In this disclosure, it is assumed that the listening environment is a vehicle. The vehicle may be any type of passenger or non-passenger vehicle, e.g., used for commercial purposes or to transport cargo. However, other types of listening environments other than a vehicle can be envisaged. The immersive loudspeaker system is, as explained above, a loudspeaker/speaker system that comprises at least one height loudspeaker and a plurality of front and rear non-height loudspeakers. The at least one height loudspeaker is located above the listener's head (in case of a vehicle, above the passenger's and/or driver's head). The non-height loudspeakers are located below the listener's head (in case of a vehicle below the passenger and/or the driver's head).

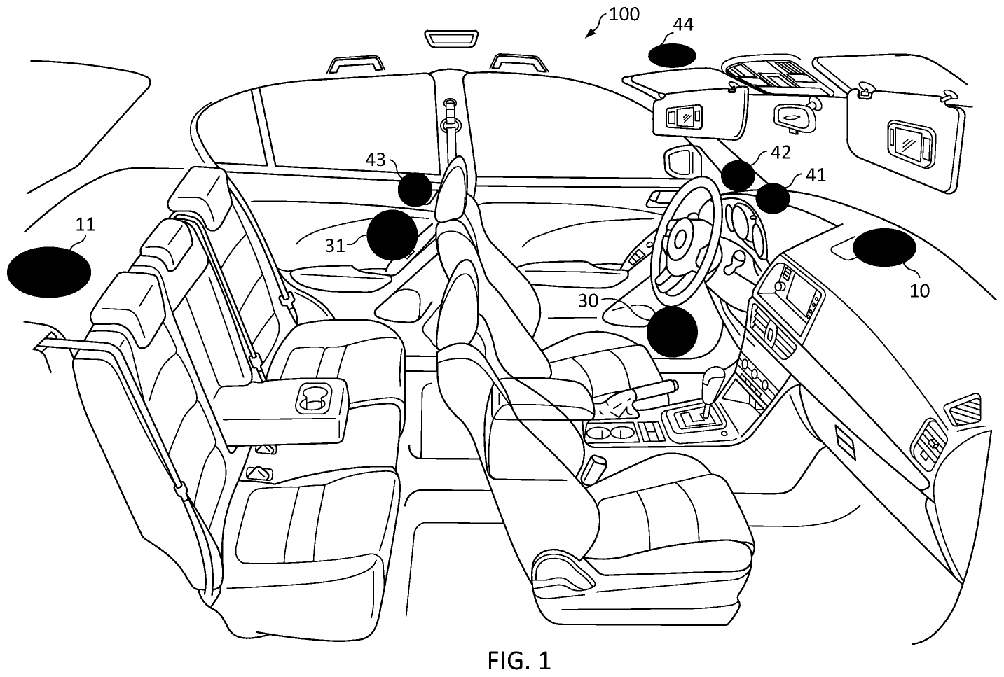

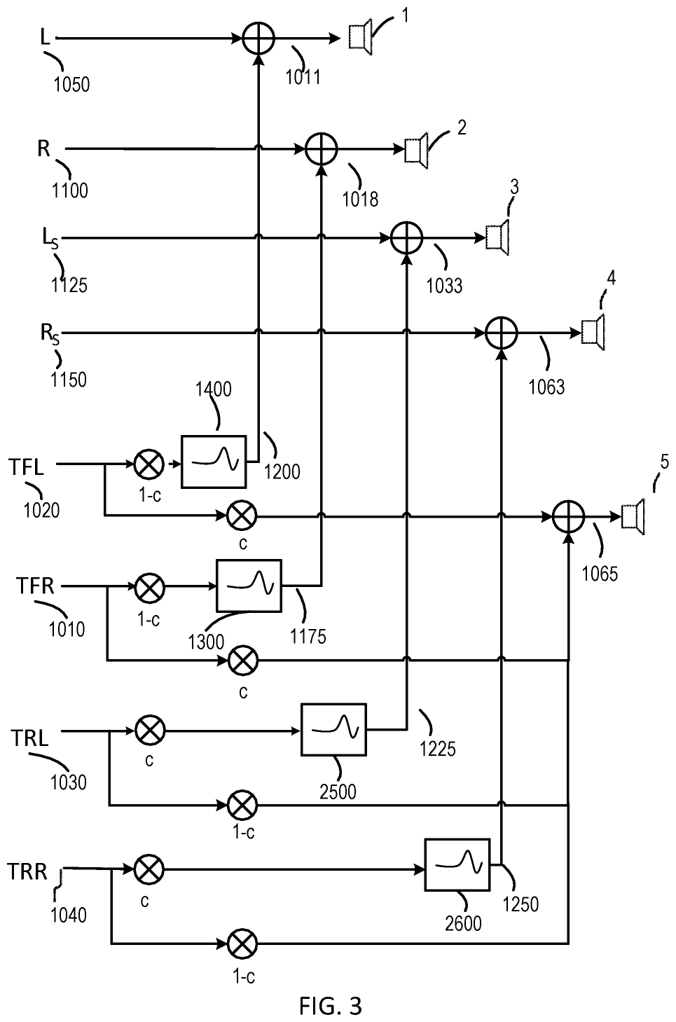

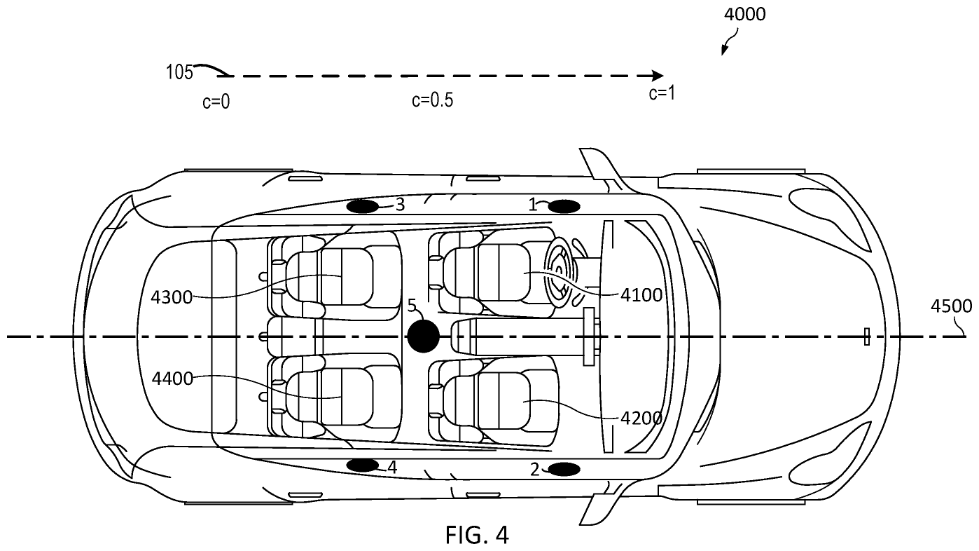

For example, with reference to FIG. 4, a top view of vehicle 4000, in this example a four-passenger car, is schematically drawn. Passenger car 4000 is an example of listening environment. Passenger car 4000 has four seats 4100, 4200, 4300 and 4400. Vehicle 4000 comprises an immersive loudspeaker system with five loudspeakers 1-5. The immersive loudspeaker of vehicle 4000 has one height loudspeaker 5, two front loudspeakers 1 and 2 and two rear loudspeakers 3 and 4. The loudspeakers at the left-hand side of vehicle 4000 and their respective counterparts at the right-hand side of vehicle 4000 are arranged reflective symmetrically with respect to a center axis 4500, crossing the center of vehicle 4000 along its length. However, other arrangements of loudspeakers 1-4 are possible. Height loudspeaker 5 is located approximatively in the middle of vehicle 4000 along the length of vehicle length. This is schematically shown by dashed arrow 105 which indicates the value of a factor c which increases from 0 at the back from vehicle 4000 to 1 at the front of vehicle 4000. In the middle of vehicle 4000, the value of factor c is 0.5. Factor c may be used by the method described with reference to FIG. 3, to calculate, based on the location of height loudspeaker 5, the portion of the height channel which is filtered by applying a so-called “virtual” filter and to calculate the remaining portion of the same height channel which is played back by height loudspeaker 5. It will be appreciated that each of seats 4100, 4200, 4300 and 4400 and thus, the potential listeners located thereof, may be symmetrically off center with respect to any pair of front loudspeakers 1 and 2 and rear loudspeakers 3 and 4. For example, a driver seating at driver seat 4100 will be symmetrically off center between front loudspeakers 1 and 2. The driver will be closer to loudspeaker 1 than to the corresponding loudspeaker 2 at the right-hand side of vehicle 4000. In FIG. 1 and FIG. 4, the driver's seat is shown at the left side (left with respect to a forward direction of driving) of the vehicle. However, it is understood that location of the driver's seat in a vehicle can be different in different regions. For example, in UK, Australia or Japan, the driver's seat is located on a right side of the vehicle with respect to the forward direction of driving the vehicle.

The immersive loudspeaker system may be for example a surround loudspeaker system with two additional height loudspeakers as shown with reference to FIG. 1. Loudspeaker system shown in FIG. 1 is a loudspeaker system with 5 front or surround loudspeakers, two left audio loudspeakers (e.g. left and left surround), two right audio loudspeakers (e.g. right and right surround), a center loudspeaker, one LFE loudspeaker and two overhead loudspeakers (left and right overhead loudspeakers). The two left audio loudspeakers correspond to loudspeakers 30, 31 (for mid-range or full range frequency), 41, 42 and 43 (for high-range frequency). The center loudspeaker corresponds to loudspeaker 10. The LFE loudspeaker corresponds to loudspeaker 11. The left overhead loudspeaker corresponds to loudspeaker 44.

Alternatively, the immersive loudspeaker system may be for example a surround loudspeaker system with a single height loudspeaker as shown with reference to FIG. 4.

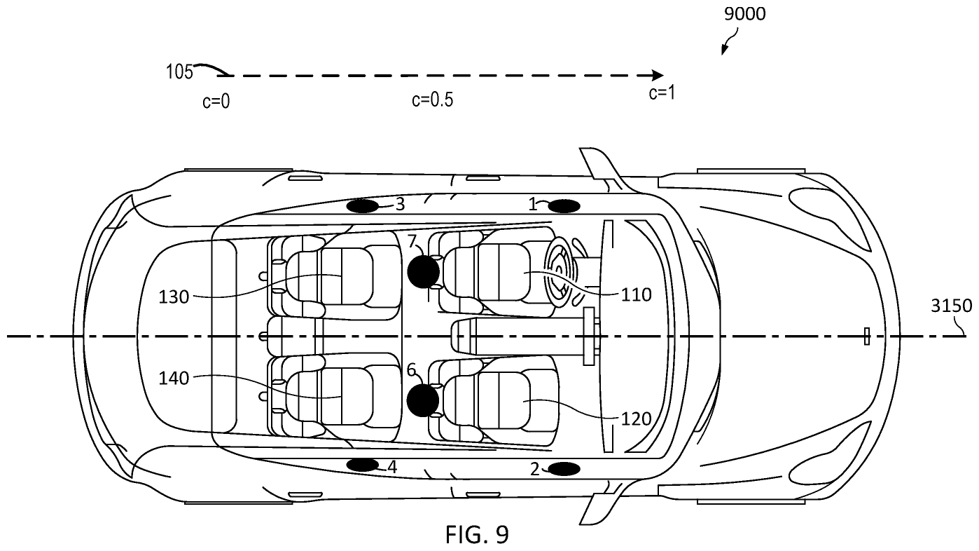

Alternatively, in another example, the immersive loudspeaker system may be for example a surround loudspeaker system with two height loudspeakers as shown with reference to FIG. 9.

With reference to FIG. 5, a top view of another exemplary vehicle 5000 is schematically shown. Vehicle 5000 may be a six or seven-passengers vehicle distributed in three different rows. Vehicle 5000 may be, for example, a Sport Utility Vehicle (SUV) or mini-bus. Vehicle 5000 has six seats 5110, 5120, 5130, 5140, 5150 and 5160. For vehicle 5000, a typical 7.1.2 loudspeaker system may be implemented. Loudspeaker system shown in FIG. 5 has three left loudspeakers 5210, 5230 and 5250 (e.g., left and two left surrounds) and three right loudspeakers 5220, 5240 and 5260 (e.g., right and two right surrounds), a center loudspeaker 5270, a LFE loudspeaker 5280 and a left middle overhead loudspeaker 5235 and right middle overhead loudspeaker 5125.

In an embodiment the audio in the immersive audio format may be audio rendered in the immersive audio format.

The immersive audio format of (e.g. rendered) audio may comprise at least one height channel. In an embodiment, the immersive audio format may be an object-based audio format supporting elevation, e.g. a Dolby Atmos format. In another embodiment, the immersive audio format may be channel-based audio format supporting elevation, e.g. a X.Y.Z audio format, where X≥2 is the number of front or surround audio channels, Y≥0 is, when present, a Low Frequency Effects or subwoofer audio channel, and Z≥1 is the at least one height audio channel. In an embodiment, the object-based audio format (e.g., supporting elevation) may be rendered or pre-rendered to a corresponding channel-based audio format for generating loudspeaker feeds corresponding to the channels of the channel-based audio format.

The method schematically illustrated in FIG. 2 will be explained also with reference to FIG. 3. FIG. 3 schematically shows an example of a method of generating a plurality of audio channels from audio in an immersive audio format according to an embodiment of the disclosure. The immersive loudspeaker system schematically shown in FIG. 3 has the same number and type of loudspeakers as shown in vehicle 4000 shown with reference to FIG. 4.

With reference to FIGS. 3, the audio in the immersive audio format may include eight audio channels: non-height front channels 1050 and 1100 (e.g., left and right front channels), non-height rear channels 1125 and 1150 (e.g., left and right rear channels or left and right surround channels), and four height channels 1020, 1010, 1030 and 1040 (e.g., top front left channel, TFL, 1020, top front right, TFR, channel 1010, top rear left channel, TRL, 1030, top rear right, TRR, channel 1040). The loudspeaker system of the example of FIG. 3 is a surround loudspeaker system of loudspeakers 1, 2, 3 and 4 with a single overhead speaker 5 (voice of God). The same loudspeaker system is shown in vehicle 4000 with reference to FIG. 4. However, a similar loudspeaker system may be used in a room or in another listening environment. In the example of FIG. 3, loudspeaker 1 is used for playback of audio in immersive audio format of channel 1050 and a portion of virtual filtered height channel 1200. In the example of FIG. 3, loudspeaker 2 is used for playback of audio in immersive audio format of channel 1100 and a portion of virtual filtered height channel 1175. Method 1000 generates a plurality of audio channels 1011, 1018, 1033, 1063 and 1065 from the audio in the immersive audio format as explained herein below. Since plurality of audio channels 1011, 1018, 1033, 1063 and 1065 are generated from eight channels 1050, 1100, 1125, 1150, 1020, 1010, 1030 and 1040 of the immersive audio forma, it can be said that the eight channels of the immersive audio format are downmixed in the plurality of five audio channels 1011, 1018, 1033, 1063 for playback by corresponding loudspeakers 1, 2, 3, 4 and 5.

With reference to FIGS. 2 and 3, method 1000 comprises applying 1500 a virtual height filter 1400, 1300, 2500 and 2600 to a portion of each of the plurality of front and rear height channels 1020, 1010, 1030 and 1040 for, when one of the front and rear height audio channels (any of channel 1020, 1010, 1030 or 1040) is played back by one of front non-height loudspeakers 1 and 2 or rear non-height loudspeakers 3 and 4, at least partially attenuating spectral components of said portion of height channel directly emanating from said non-height loudspeaker and for at least partially amplifying spectral components of said portion of height channel reflected from a roof or an area close to the roof inside the listening environment, which in this example is a vehicle, to generate a plurality of front virtual height filtered audio signals 1200 and 1175 and rear virtual height filtered audio signals 1225 and 1250. With reference to FIG. 2 method 1000 further comprises adding 1700 each of the plurality of front virtual height filtered audio signals 1200 and 1175 to the corresponding front non-height audio channels 1050 and 1100 to generate added audio signals 1011 and 1018 for playback by corresponding front loudspeakers 1 and 2. Method 1000 further comprises adding 1700 rear virtual height filtered audio signal 1225 and 1250 to non-height audio channels 1125 and 1150 to generate added audio signals 1033 and 1063 for playback by corresponding loudspeakers 3 and 4. Method 1000 further comprises playing back 1750 the remaining portion of each of the plurality of front and rear height channels 1020, 1010, 1030 and 1040 with the at least one height loudspeaker 5. It can be seen from FIG. 3 that the remaining portions of front and rear height channels 1020, 1010, 1030 and 1040 are summed up to signal 1065 which feeds height loudspeaker 5.

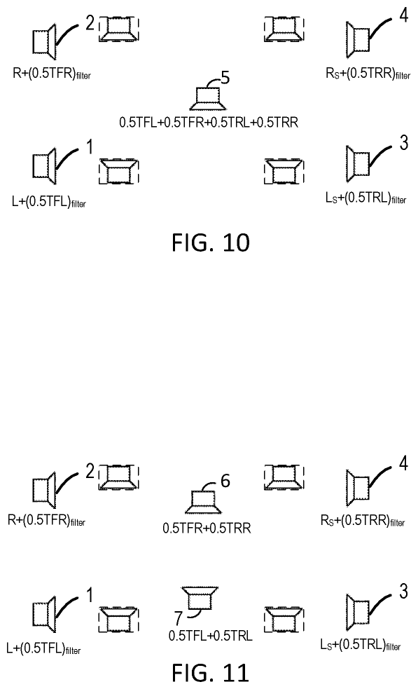

In an embodiment, the portion of the front and rear height channels to which the virtual height filter is applied is a function of a location of the at least one height loudspeaker along a length of the vehicle. In an embodiment, the portion of the front and rear height channels to which the virtual height filter is applied is a linear function of the location of the at least one height loudspeaker along a length of the vehicle. For example, as shown in FIG. 4 height (or overhead) loudspeaker 5 may be located at the middle of vehicle 4000 along its length and along axis 4500. As explained above, in the example FIG. 4, height loudspeaker 5 is located at the middle of vehicle 4000. Location of height loudspeaker 5 is schematically indicated in FIG. 4 by the value of multiplying factor. When height loudspeaker 5 is located in the middle along the length of vehicle 4000, c=0.5. In this example, with reference to FIG. 3, when height (or overhead) loudspeaker 5 is located in the middle of the vehicle along its length, 50% of the energy of each height channel 1020, 1010, 1030 and 1040 may be “virtual” filtered by corresponding virtual filter 1400, 1300, 2500 and 2600, and 50% of the remaining energy may be played back height loudspeaker 5. This example is schematically represented with reference to FIG. 10. FIG. 10 schematically shows an example of the energy distribution of the audio systems in the loudspeaker system of vehicle 4000 of FIG. 4 by using the exemplary method of FIG. 3. If c=0.5 when height loudspeaker 5 is located in the middle of vehicle 4000, the audio signal fed to height loudspeaker 5 is 0.5TFL+0.5TFR+0.5TRL+0.5TRR. The audio signal fed to loudspeaker 1 is L+(0.5TFL)_{filter}, i.e., equal to the energy of the non-height front left channel plus half of the energy of the top front left channel filtered by virtual filter 1400. The audio signal fed to loudspeaker 2 is R+(0.5TFR)_{filter}, i.e., equal to the energy of the non-height front right channel plus half of the energy of the top front right channel filtered by virtual filter 1300. The audio signal fed to loudspeaker 3 is L_{S}+(0.5TRL)_{filter}, i.e., equal to the energy of the non-height rear (or surround) left channel plus half of the energy of the top rear left channel filtered by virtual filter 2500. The audio signal fed to loudspeaker 4 is R_{S}+(0.5TRR)_{filter}, i.e., equal to the energy of the non-height rear (or surround) right channel plus half of the energy of the top rear right channel filtered by virtual filter 2600. The energy distribution is such to conserve the energy among the loudspeakers of the loudspeaker system, i.e. the distribution is energy neutral. The effect is schematically shown in FIG. 10 by the loudspeakers circled with a dashed line. Sound in the height plane is distributed among the “virtual’ loudspeakers circled with a dashed line and a listener has the perception that the sound in the height plane, i.e. sound related to the height channels of the immersive audio format, is emanated by such virtual loudspeakers. Sound in the height plane has an improved spatial resolution compared to conventional methods using a single height loudspeaker. It can be said that the perception of the listener of sound in the height plane is that of the sound produced by a helicopter, i.e. as if the audio is emanated from all directions surrounding the listener even by using a single height loudspeaker. In conventional prior art solutions, i.e., without redistribution of the height channels among the height and non-height loudspeakers of the immersive loudspeaker system and without “virtual” filtering the portions of the height channels which are fed to the non-height loudspeakers, no helicopter effect would be produced but the sound would be perceived as just emanated by the physical location of the single height loudspeaker.

In an embodiment, applying the virtual height filter to a portion of each of the plurality of front and rear height channels comprises applying the virtual height filter to a portion of the front height channels which is proportional to a location of the at least one height loudspeaker moving away from the front and getting close to the rear of the listening environment. For example, with reference to FIG. 4, the value of c may decrease when the location of height loudspeaker 5 is getting close to the rear of vehicle 4000. In the example of FIG. 3, the portions of top front left and right channels (TFL and TFR) feeding loudspeakers 1 and 2 proportionally increase when the value of c decreases, i.e. in this specific example such portions increase by the factor 1-c.

In yet an embodiment, applying the virtual height filter to a portion of each of the plurality of front and rear height channels comprises applying the virtual height filter to a portion of the rear height channels which is proportional to a location of the at least one height loudspeaker moving away from the rear and getting close to the front of the listening environment. For example, with reference to FIG. 4, the value of c may increase when the location of height loudspeaker 5 is getting close to the front and moving away from the rear of vehicle 4000. In the example of FIG. 3, the portions of top rear left and right channels (TRL and TRR) feeding loudspeakers 3 and 4 proportionally increase when the value of c increase, i.e. in this specific example such portions increase by the factor c.

Similarly, in an embodiment, playing back the remaining portion of each of the plurality of front and rear height audio channels with the at least one height loudspeaker comprises playing back a remaining portion of each of the plurality of the front height audio channels which is proportional to a location of the at least one height loudspeaker moving away from the rear and getting close to the front of the listening environment. For example, with reference to FIG. 4, the value of c may increase when the location of height loudspeaker 5 is getting close to the front and moving away from the rear of vehicle 4000. In the example of FIG. 3, the remaining portions of top front left and right channels (TFL and TFR) feeding height loudspeaker 5 proportionally increase when the value of c increase, i.e. in this specific example such remaining portions increase by the factor c.

Similarly, in an embodiment, playing back the remaining portion of each of the plurality of front and rear height audio channels with the at least one height loudspeaker comprises playing back a remaining portion of each of the plurality of the rear height audio channels which is proportional to a location of the at least one height loudspeaker moving away from the front and getting close to the rear of the listening environment. For example, with reference to FIG. 4, the value of c may decrease when the location of height loudspeaker 5 is getting close to the rear and away from the front of vehicle 4000. In the example of FIG. 3, the remaining portions of top rear left and right channels (TRL and TRR) feeding height loudspeaker 5 proportionally increase when the value of c decreases, i.e. in this specific example such remaining portions increase by the factor 1-c.

It is understood that the embodiment described with reference to FIGS. 3, 4 and 10 is just an example of how distribution of energy from height channels to non-height loudspeakers can be implemented. In practical implementations the portion(s) of height channels to be filtered by virtual filter feeding non-height loudspeakers may not be dependent by the location of the height loudspeaker. In practical implementations the portion(s) of height channels to be filtered by virtual filter feeding non-height loudspeakers may be determined based on the best performance of the loudspeaker system, e.g. based on the best immersive audio experience for the listener. Similarly, in embodiments of the present disclosure factor c may be tuned for the best immersive audio experience of the listener, e.g., instead of being based on the location of the at least one height loudspeaker. It is also understood that embodiments of the present disclosure are not limited to the use of factor c as shown in FIG. 3: other linear or non-linear functions of the location of the height loudspeaker or other linear or non-linear functions of other parameters of the height and/or non-height audio channels like, e.g., volume level, equalization level, dialog enhancement, can be envisaged. Other ratios of the portion of height channel which is virtual filtered versus the remaining portion of height channel which is played back by the height loudspeaker can be chosen according to the suitable implementation.

In an embodiment, the portion of the front and rear height channels to which the virtual height filter is applied is a function of a desired balance distribution of the plurality of audio channels among the loudspeakers of the immersive loudspeaker system. The desired balance distribution may provide the best immersive audio experience for the listener. For example, during a calibration or test phase, it may be found that a particular ratio of the portion of height channel which is virtual filtered versus the remaining portion of height channel which is played back by the height loudspeaker provides a desired height spatial resolution, i.e. spatial resolution in the height plane.

In another embodiment, the portion of the front and rear height channels to which the virtual height filter is applied is both a function of a desired balance distribution of the plurality of audio channels among the loudspeakers of the immersive loudspeaker system and the location of the at least one height loudspeaker along a length of the vehicle. The desired spatial resolution in the height plane may be a function of the location of the height (or overhead) loudspeaker.

In general, as explained above, the choice of the portion of the front and rear height channels which is filtered by the virtual height filter is made on empirical data or experiments which provide the best performance of the immersive loudspeaker system.

In an embodiment, the portion of the front or rear height channels to which the virtual height filter is applied may be a function of a position of the listener (driver or passenger), relative to the position of the height (or overhead) loudspeaker. In an embodiment, the portion of the front or rear height channels to which the virtual height filter is applied may be dynamically adjusted/triggered in function of a change of the position of the listener relative to the position of the height (or overhead) loudspeaker. For example, the position of the listener may be adjusted in the height plane or base plane and the portion of the front or rear height channels to which the virtual height filter is applied may be changed based on this adjustment. For example, the adjustment of the portion can be triggered by an adjustment of the seat in any direction of the vehicle.

Virtual height filter 1300 is configured to at least partially attenuate spectral components of a portion of height channel 1010 which are directly emanating from loudspeaker 2, when such a portion of height channel 1010 is played back by such loudspeaker 2. Virtual height filter 1300 is further configured to at least partially amplify spectral components of the portion of height channel 1010 reflected from a roof or an area close to the roof inside the vehicle, to generate virtual height filtered audio signal 1175. Virtual height filter 1400 is configured to at least partially attenuate spectral components of a portion of height channel 1020 which are directly emanating from loudspeaker 1, when such portion of height channel 1020 is played back by such loudspeaker 1. Virtual height filter 1400 is further configured to at least partially amplify spectral components of the portion of height channel 1020 reflected from a roof or an area close to the roof inside the vehicle, to generate virtual height filtered audio signal 1200. Virtual height filter 2500 is configured to at least partially attenuate spectral components of a portion of height channel 1030 which are directly emanating from loudspeaker 3, when such portion of height channel 1030 is played back by such loudspeaker 3. Virtual height filter 2500 is further configured to at least partially amplify spectral components of the portion of height channel 1030 reflected from a roof or an area close to the roof inside the vehicle, to generate virtual height filtered audio signal 1225. Virtual height filter 2600 is configured to at least partially attenuate spectral components of a portion of height channel 1030 which are directly emanating from loudspeaker 4, when such portion of height channel 1040 is played back by such loudspeaker 4. Virtual height filter 2600 is further configured to at least partially amplify spectral components of the portion of height channel 1040 reflected from a roof or an area close to the roof inside the vehicle, to generate virtual height filtered audio signal 1250.

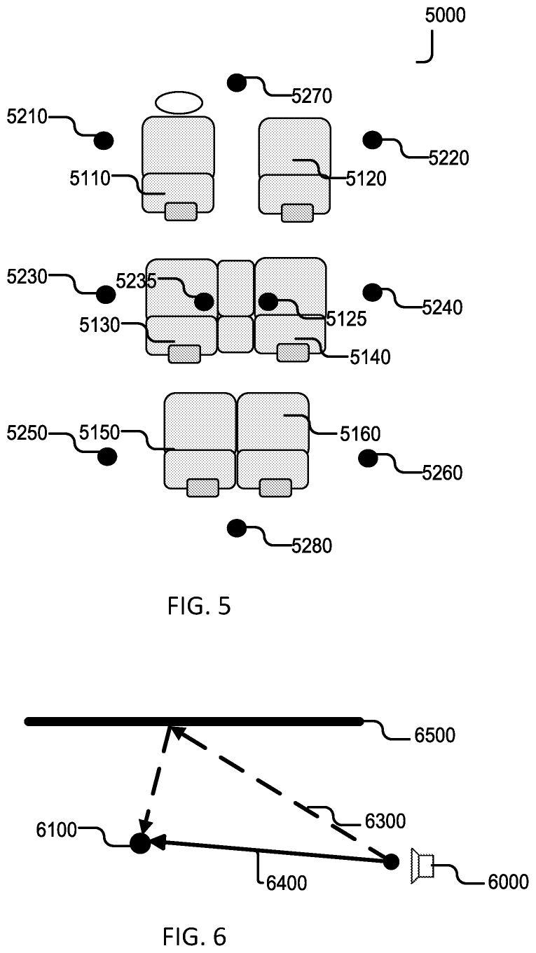

To explain further, reference is made to FIG. 6, which schematically shows exemplary paths 6300 and 6400 that sound played back by a loudspeaker 6000 may travel from loudspeaker 6000 to a listening position 6100, e.g., inside a vehicle. Loudspeaker 6000 may be any of the non-height loudspeakers shown with reference to, e.g., loudspeaker systems of FIG. 1 and FIG. 3. In particular loudspeaker 6000 may be any of the front or rear (or surround) left, right loudspeakers shown therein. Preferably, since height cues are typically more prevalent in high frequency signals rather than low frequency signals, loudspeaker 6000 may be any high frequency loudspeaker associated with any of the left, right or surround loudspeakers, such as, for example, speakers (e.g. tweeters) 41, 42 and 43 shown in FIG. 1. Listening position 6100 may be at the ears/head of the passenger or driver of the vehicle. Sound played back by loudspeaker 6000 may radiate along a reflected path 6300, indicated by a dashed line in FIG. 6, and along a direct path 6400, indicated by a solid line in FIG. 6. Reflected path 6300 is an indirect path from loudspeaker 6000 to listening position 6100 and is formed by the sound being reflected from a surface 6500 located above listening position 6100. Inside a listening environment, surface 6500 may be the ceiling of a room or an area close to the ceiling of the room. Inside a vehicle, surface 6500 may be the roof of the vehicle or an area close to the roof of the vehicle. The area close to the roof may be the upper inner parts of the front windshield or rear windshield or the upper inner parts of the lateral windows of the vehicle. In general, surface 6500 may be any part of the interior of the vehicle which is, during sound playback, located at a higher elevation than (e.g. above) the listening position. For an increased perception of sound elevation, it is desirable that the sound radiates along reflected path 6300. However, some sound from loudspeaker 6000 will travel along direct path 6400, diminishing the perception of sound coming from a position at surface 6500 in which sound is reflected off to listening position 6100. The amount of this undesired direct sound in comparison to the desired reflected sound may be a function of a directivity pattern of loudspeaker 6000. It has been found that non-height loudspeakers located at approximately half the whole height of the interior of the vehicle (e.g., approximately at the door middle height) provide for an enhanced perception of sound elevation.

To compensate for the undesired direct sound, it has been shown that incorporating signal processing to introduce perceptual height cues into the audio signal being fed to loudspeaker 6000 improves the positioning and perceived quality of the virtual height signal. For example, a directional hearing model has been developed to create a virtual height filter, which when used to process audio being reproduced by a loudspeaker, improves that perceived quality of the reproduction. In an embodiment, the virtual height filter is derived from both a physical loudspeaker location and a virtual loudspeaker location (above the listening position) with respect to the listening position. For the physical loudspeaker location, a first directional filter is determined based on a model of sound travelling directly from the loudspeaker location to the ears of a listener at the listening position. Such a filter may be derived from a model of directional hearing such as a database of HRTF (head related transfer function) measurements or a parametric binaural hearing model, pinna model, or other similar transfer function model that utilizes cues that help perceive height. Although a model that takes into account pinna models is generally useful as it helps define how height is perceived, the filter function is not intended to isolate pinna effects, but rather to process a ratio of sound levels from one direction to another direction, and the pinna model is an example of one such model of a binaural hearing model that may be used, though others may be used as well.

An inverse of this filter is next determined and used to remove the directional cues for audio travelling along a path directly from the physical loudspeaker location to the listening position. Next, for the virtual loudspeaker location, a second directional filter is determined based on a model of sound travelling directly from the virtual loudspeaker location to the ears of a listener at the same listening position using the same model of directional hearing. This filter is applied directly, imparting the directional cues the ear would receive if the sound were emanating from the virtual loudspeaker location above the listening position. In practice, the first directional filter and the second directional filter may be combined in a way that allows for a single filter that both at least partially removes (attenuates) the directional cues from the physical loudspeaker location, and at least partially inserts (amplify) the directional cues from the virtual loudspeaker location. Such a single filter provides a frequency response curve that is referred to herein as a “height filter transfer function,” “virtual height filter response curve,” “desired frequency transfer function,” “height cue response curve,” or similar words to describe a filter or filter response curve that filters, e.g., attenuate, direct sound components from height sound components in an audio loudspeaker system.

With regard to the filter model, if P1 represents the frequency response in dB of the first filter modeling sound transmission from the physical loudspeaker location and P2 represents the frequency response in dB of the second filter modeling sound transmission from the virtual loudspeaker location, then the total response of the virtual height filter PT in dB can be expressed as: PT=α(P2−P1), where a is a scaling factor or gain that controls the strength of the filter. With α=1, the filter is applied maximally, and with α=0, the filter does nothing (0 dB response). In practice, a may be set somewhere between 0 and 1 (e.g. α=0.5) based on the relative balance of reflected to direct sound. As the level of the direct sound increases in comparison to the reflected sound, so should a in order to more fully impart the directional cues of the virtual loudspeaker location to this undesired direct sound path. However, a should not be made so large as to damage the perceived timbre of audio travelling along the reflected path, which already contains the proper directional cues. In general, the exact values of the filters P1 and P2 will be a function of the azimuth of the physical loudspeaker location with respect to the listening position and the elevation of the reflected speaker location. This elevation is in turn a function of the distance of the physical loudspeaker location from the listening position and the difference between the height of the roof or area close to the roof (surface 6500 in FIG. 6) and the height of the speaker.

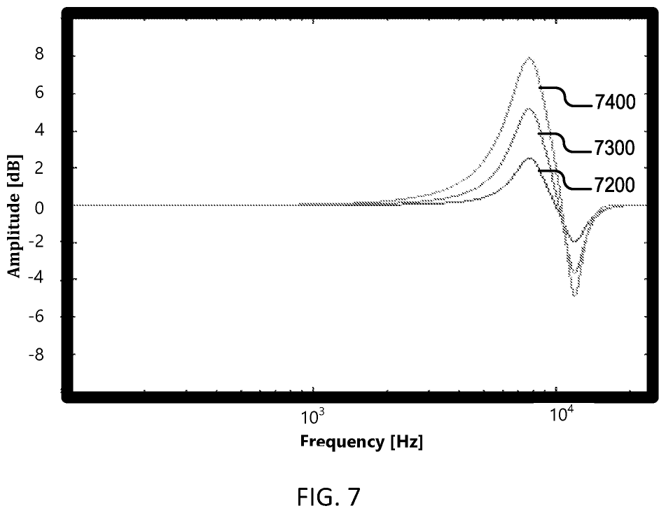

FIG. 7 shows example curves 7200, 7300 and 7400 of a virtual height filter according to some embodiments of the present disclosure. Curves 7200, 7300 and 7400 are represented in a diagram showing, in the ordinate, the amplitude of the virtual height filter, in Decibels (dB), versus, in the abscissa, the frequency, in Hertz (Hz).

Curves 7200, 7300 and 7400 represent filter transfer functions for three different virtual height filters. FIG. 7 shows that filter transfer functions 7200, 7300 and 7400 of the three different filters have a peak at a first frequency of about 8000 Hertz and a notch at a second frequency higher than the first frequency of about 12000 Hertz. However, the peak and the notch may be at different frequencies. The three different transfer functions may be obtained by applying a different scaling factor/different gain to a virtual height filter, as explained above. In an embodiment, the gains may be user-configurable such that the ‘strength’ of the virtual height filter can be tuned by the user according to the specific implementation.

In an embodiment, as shown with reference to FIG. 2, the method of the present disclosure may further comprise determining 1800 the filter transfer function of the virtual height filter from one or more parameters identifying the filter transfer function. For example, the one or more parameters may be indicative of at least one value of the peak, the frequency of the peak, the notch and the frequency of the notch of the filter transfer function representing the virtual height filter. For example, the parameters may be stored in a memory or processor containing a memory, e.g., as a look-up table or analytical function. These parameters may be retrieved by a processing unit from the memory which may reconstruct the virtual height filter therefrom. The reconstructed virtual height filter may be thus used and applied to the height channel. By using one or more parameters to identify the filter transfer function, processing of the height channels is simplified as the virtual height filter is described by a few parameters instead of being generated locally.

The two front and/or the two rear non-height loudspeakers are laterally spaced with respect to a listening position (e.g., a driver or a passenger position in case of a vehicle). In an embodiment, as shown with reference to FIG. 2, the method of the present disclosure may further comprise determining 1850 the filter transfer function for the virtual height filter based on a relative distance of the two non-height front and/or rear loudspeakers from the listening position and on an elevation of the roof or area close to the roof relative to the listening position.

For example, in one embodiment, one or more sensors may be located at or close to the listening positions to measure such relative distance of the at the least two front or rear loudspeakers from the listening position and the elevation of the roof or area close to the roof, relative to the listening position. For example, in an embodiment, such sensors may be embedded in the head rest of each seat of the vehicle approximatively at the same height of the listener's head. Said measurements may be performed at an initial calibration stage of the method or, alternatively, substantially real-time with playback of the audio.

Alternatively, additionally or optionally the filter transfer function of the virtual height filter may be based on predetermined absolute distances between the one or more listening positions and each of the non-height front and/or rear loudspeakers and predetermined elevation of the roof relative to the listening position. For example, distances between the one or more listening positions (for example any of the positions at seats 4100, 4200, 4300 or 4400 of FIG. 4) and the pair of non-height front loudspeaker 1 and 2 and/or non-height rear loudspeakers 3 and 4 as well as the elevation of the roof may be determined/predetermined by the environment characteristics, e.g. the vehicle's interior design, and loudspeaker installation. The method of this disclosure may use this predetermined information for obtaining the filter transfer function of the virtual height filter. For example, in an embodiment, the step of determining 1800 the filter transfer function of the virtual height filter from one or more parameters may involve accessing predetermined parameters. For example, the parameters may have been obtained/measured for one vehicle of a certain type, and subsequently stored in the memory of an on-board computing system of vehicles of the same type. Such offline calibration has the advantage that vehicles do not need to be equipped with sensors for measuring and obtaining the filter transfer function online.

Alternatively, additionally or optionally, in an embodiment as shown with reference to FIG. 2, method 1000 may further comprise, typically prior step 1500, obtaining 1900 a plurality of filter transfer functions for a plurality of virtual height filters. The plurality of virtual height filters may be obtained based on a range of relative distances of the plurality of height and non-height loudspeakers from the listening position and on a range of elevations of the roof or area close to the roof relative to the listening position. For example, the range of distances non-height or height loudspeakers-listening position(s) may be measured, e.g. during a calibration phase, for a plurality of different listening positions and/or a plurality of non-height or height loudspeaker locations. Similarly, the range of elevations of the roof (or the virtual loudspeaker location thereof) may be measured, e.g. during a calibration phase, for a plurality of different listening positions. Method 1000 further comprises selecting 2000 one filter transfer function from the plurality of filter transfer functions. For example, in an embodiment, the selected filter transfer function may be based on an average distance of the height loudspeaker from the listening position and based on an average elevation of the roof or area close to the roof (or of the virtual loudspeaker location) relative to the listening position. In another embodiment, the selected (filter transfer function of the) virtual height filter is the average of the plurality of filter transfer functions. For example, the selected transfer function may be determined by interpolating among the plurality of filter transfer functions. In yet another embodiment, method 1000, including steps 1900 and 2000 may be, e.g., during a calibration phase and as indicated in FIG. 2, iteratively applied for each filter transfer function selected at each iteration until the selected filter transfer function provides optimal (e.g., maximize the) perception of sound elevation with the desired spatial resolution in the height plane at the one or more listening positions. In other words, method 1000, including steps 1900 and 2000 may be iteratively applied until the (selected) filter transfer function provides a playback of the plurality of audio channels with maximum spatial resolution in the height plane. In general, for a simple and more effective audio processing in a specific type of vehicle, a single filter transfer function that on average performs well for most of listening positions/loudspeaker locations and elevations of the roof or area close to the roof (or elevations of the virtual loudspeaker location) may be selected. However, the filter transfer function may be adaptively determined substantially real time, e.g., by means of sensors as explained above. Adaptively determining the filter transfer function may provide a more accurate determination of the filter transfer functions and therefore an enhanced spatial resolution in the height plane.

In an embodiment, still with reference to FIG. 2, each filter transfer function of the plurality of transfer functions as obtained in step 1900 may be determined from one or more parameters, e.g. stored in a memory, as LUT or analytical function, as explained above. The method may actively/adaptively select the parameters of the filter transfer function for the specific vehicle type or when sensors are used.

In an embodiment, still with reference to FIG. 2, the step of determining 1800 the filter transfer function of the virtual height filter from one or more parameters (either based on predetermined distance/elevation information or based on actual measurements) may be triggered upon detection of a movement of a listener located at the one or more listening positions. For example, one or more sensors may be employed to detect the movement of the listener. When employed in the interior of a vehicle, such sensors may be, e.g., located at respective seats of the vehicle. Said one or more sensors may be configured to detect the presence of a passenger or driver in a vehicle and thus enabling use of the correct distance information to be used by the processing method to obtain the filter transfer function.

In an embodiment, said one or more seat sensors or a different set of sensors may be used to detect a new listening position, e.g., a new location of the listener's head (or location of the listener's hears). For example, the driver or passenger may adjust his own seat horizontally and/or vertically for a more comfortable seating position in the vehicle. In this embodiment, the method may retrieve/obtain (the filter transfer function of) the virtual height filter according to the new detected listening position. In this way the correct information, either based on a correct set of predetermined listener to loudspeakers distance information and set of predetermined roof elevation information, or based on actual measurements, may be used according to the new listening position. For example, if/when the predetermined one or more parameters identifying (the filter transfer function of) the virtual height filter are stored as an analytical function or a look up table (LUT), a different analytical function or a different LUT may correspond to a different (e.g. detected) seat or listening position. These embodiments in which step 1800 may be triggered upon detection of a movement of a listener may be combined with the embodiments described above in which the portion of the front or rear height channels to which the virtual height filter is applied may be dynamically adjusted/triggered in function of a change of the position of the listener relative to the position of the height (or overhead) loudspeaker. For example, both the one or more parameters identifying a particular filter transfer function and the portion of the front or rear height to which the particular filter transfer function is applied may be determined upon detection of a new listener position and/or based on the new listener position. The new listener position may be determined with any sensor or set of sensors described above. Therefore, yet a more accurate and targeted determination of the filter transfer functions and ratio of the portions of height channels which are to be filtered and the remaining portions of the height channels which are to be played back by the height loudspeaker can be achieved.

As explained above, the immersive loudspeaker system may comprise two height loudspeakers.

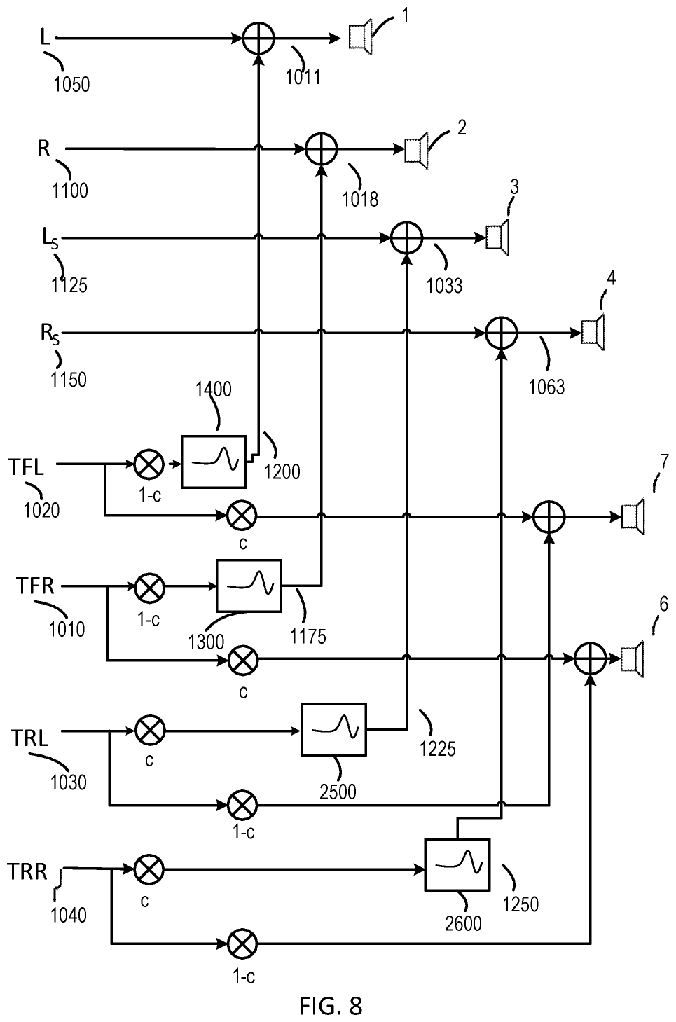

For example, with reference to FIG. 8, the immersive loudspeaker system comprises two height loudspeakers 6 and 7 and four non-height loudspeakers 1, 2, 3 and 4. Two height loudspeakers 6 and 7 may be a top right height loudspeaker and a top left height loudspeaker, respectively, as shown in vehicle 8000 of FIG. 9. FIG. 9 schematically shows vehicle 9000. Vehicle 9000 is similar to vehicle 4000 shown with reference to FIG. 4 but includes a immersive loudspeaker system having two height loudspeakers 6 and 7. Similar to vehicle 4000 of FIG. 4 height loudspeakers 6 and 7 in the example of FIG. 9 are located in the middle of vehicle 9000 along its length. Middle location of height loudspeakers 6 and 7 is indicated by a value of factor c of 0.5. The (input) immersive audio format used with reference to the example shown in FIG. 8 has eight audio channels and it is the same of that described with reference to FIG. 3 and will be here not repeated.

Virtual height filter 1300 is applied to a portion of height channel 1010 to generate virtual height filtered signal 1175. Virtual height filtered signal 1175 is added with non-height channel 1100 to generate signal 1018. Virtual height filter 1400 is applied to a portion of height channel 1020 to generate virtual height filtered signal 1200. Virtual height filtered signal 1200 is added with non-height channel 1050 to generate signal 1011. Virtual height filter 2500 is applied to a portion of height channel 1030 to generate virtual height filtered signal 1225. Virtual height filtered signal 1225 is added with non-height channel 1125 to generate signal 1033. Virtual height filter 2600 is applied to a portion of height channel 1040 to generate virtual height filtered signal 1250. Virtual height filtered signal 1250 is added with non-height channel 1150 to generate signal 1063. Channel signals 1011, 1018, 1033 and 1063 are fed to loudspeakers 1, 2, 3, and 4, respectively, for playback. The remaining portion of height channel 1020 is fed together with the remaining portion of height channel 1030 to height loudspeaker 7. The remaining portion of height channel 1010 is fed together with the remaining portion of height channel 1040 to height loudspeaker 6. By using two height loudspeakers 6 and 7 and the redistribution of the height channels among the height and the non-height loudspeakers of the immersive loudspeaker system, the spatial resolution in the height plane is further improved. This is better explained with reference to FIG. 11.

FIG. 11 schematically shows an example of the energy distribution of the audio systems in the loudspeaker system of vehicle 9000 of FIG. 9 by using the exemplary method of FIG. 8. If c=0.5 when height loudspeakers 6 and 7 are located in the middle of vehicle 9000, the audio signal fed to height loudspeaker 6 is 0.5TFR+0.5TRR and the audio signal fed to height loudspeaker 7 is 0.5TFL+0.5TRL. The audio signal fed to loudspeaker 1 is L+(0.5TFL)_{filter}, i.e., equal to the energy of the non-height front left channel plus half of the energy of the top front left channel filtered by virtual filter 1400. The audio signal fed to loudspeaker 2 is R+(0.5TFR)_{filter}, i.e., equal to the energy of the non-height front right channel plus half of the energy of the top front right channel filtered by virtual filter 1300. The audio signal fed to loudspeaker 3 is L_{S}+(0.5TRL)_{filter}, i.e., equal to the energy of the non-height rear (or surround) left channel plus half of the energy of the top rear left channel filtered by virtual filter 2500. The audio signal fed to loudspeaker 4 is R_{S}+(0.5TRR)_{filter}, i.e., equal to the energy of the non-height rear (or surround) right channel plus half of the energy of the top rear right channel filtered by virtual filter 2600. The energy distribution is such to conserve the energy among the loudspeakers of the loudspeaker system, i.e. the distribution is energy neutral. The effect is schematically shown in FIG. 11 by the loudspeakers circled with a dashed line. Sound in the height plane is distributed among the “virtual’ loudspeakers circled with a dashed line and a listener has the perception that the sound in the height plane, i.e. sound related to the height channels of the immersive audio format, is emanated by such virtual loudspeakers. Sound in the height plane has an improved spatial resolution compared to conventional methods using two height loudspeakers. It can be said that the perception of the listener of sound in the height plane is that of the sound produced by a helicopter, i.e. as if the audio is emanated from all directions surrounding the listener even by using two height loudspeakers. In conventional prior art solutions, i.e., without redistribution of the height channels among the height and non-height loudspeakers of the immersive loudspeaker system, and without “virtual” filtering the portions of the height channels which are fed to the non-height loudspeakers, no helicopter effect would be produced but the sound would be perceived as just emanated by the physical locations of the two height loudspeakers.

It is understood that the various ways of determining the portions of the height channels based of height loudspeaker(s) which are virtual filtered and which have been described with reference to the embodiment of FIGS. 3, 4 and 10, are also applicable to the embodiment of FIGS. 8, 9 and 11 having two height loudspeakers. These various ways of determining the portions of the height channels is therefore here not repeated.

It is also understood that similarly to the embodiment described with reference to FIGS. 3, 4 and 10 also the embodiment described with reference to FIGS. 8, 9 and 11 is just an example of how distribution of energy from height channels to non-height loudspeakers can be implemented. In practical implementations, the portion(s) of height channels to be filtered by virtual filter feeding non-height loudspeakers may not be dependent by the location of the height loudspeaker. In practical implementations the portion(s) of height channels to be filtered by virtual filter feeding non-height loudspeakers may be determined based on the best performance of the loudspeaker system, e.g. based on the best immersive audio experience for the listener. Similarly, in embodiments of the present disclosure factor c may be tuned for the best immersive audio experience of the listener, e.g., instead of being based on the location of the two height loudspeakers. It is also understood that embodiments of the present disclosure are not limited to the use of factor c as shown in FIG. 9: other linear or non-linear functions of the location of the height loudspeakers or other linear or non-linear functions of other parameters of the height and/or non-height audio channels like, e.g., volume level, equalization level, dialog enhancement, can be envisaged. Other ratios of the portion of height channel which is virtual filtered versus the remaining portion of height channel which is played back by the height loudspeaker can be chosen according to the suitable implementation. For example, c may be equal to 0.25 if height loudspeakers 6 and 7 are located between the rear and the middle of vehicle 9000. For example, c may be 0.75 if height loudspeakers 6 and 7 are located between the middle and the front of vehicle 9000. Alternatively, c may be still equal to 0.25 or 0.75 (or any other value suitable for the specific implementation) independently from the location of loudspeakers 6 and 7.

In an embodiment, the portion of the front and rear height channels to which the virtual height filter is applied is a function of a desired balance distribution of the plurality of audio channels among the loudspeakers of the immersive loudspeaker system. The desired balance distribution may provide the best immersive audio experience for the listener. For example, during a calibration or test phase, it may be found that a particular ratio of the portion of height channel which is virtual filtered versus the remaining portion of height channel which is played back by the height loudspeaker provides a desired height spatial resolution, i.e. a desired spatial resolution in the height plane.

In another embodiment, the portion of the front and rear height channels to which the virtual height filter is applied is both a function of a desired balance distribution of the plurality of audio channels among the loudspeakers of the immersive loudspeaker system and the location of the at least one height loudspeaker along a length of the vehicle. The desired spatial resolution in the height plane may be a function of the location of the height (or overhead) loudspeaker.

In general, as explained above, the choice of the portion of the front and rear height channels which is filtered by the virtual height filter is made on empirical data or experiments which provide the best performance of the immersive loudspeaker system.

In an embodiment, the portion of the front or rear height channels to which the virtual height filter is applied may be a function of a position of the listener (driver or passenger), relative to the position of the height (or overhead) loudspeaker. In an embodiment, the portion of the front or rear height channels to which the virtual height filter is applied may be dynamically adjusted/triggered in function of a change of the position of the listener relative to the position of the height (or overhead) loudspeaker. For example, the position of the listener may be adjusted in the height plane or base plane and the portion of the front or rear height audio channels to which the virtual height filter is applied may be changed based on this adjustment. For example, the adjustment of the portion can be triggered by an adjustment of the seat in any direction of the vehicle.

Any other suitable immersive audio format and/or speaker configuration can be envisaged, suitable for the specific implementation.

For example, in addition to the (input) channels of the examples shown with reference to FIGS. 3 and 8, the audio in the immersive audio format may also include a center (C) channel and/or a Low Frequency Effect (LFE) channel (not shown in any of the FIG. 3 or 8). As explained above, since height cues are typically more prevalent in high frequency signals rather than low frequency signals, when present, the center channel and/or the LFE channel are typically not mixed/added with the virtual filtered height channels but directly fed to corresponding loudspeakers (e.g. Center and LFE loudspeakers).

In some embodiments (not shown in the Figures), when the center channel is present in the input immersive audio format, the center channel may be mixed/added together with the non-height Front Left and Front Right channels. In such embodiments, adding the virtual filtered height channel(s) to the non-height audio channel(s) (i.e. the Front Left and/or the Front Right channels) may be performed after mixing the Front Left and Front Right channels with the Center channel. In other words, in such embodiments, the non-height channel signal that is added to the virtual filtered signal has been already mixed with the center channel.

Similar considerations are applicable for loudspeaker configurations as shown in FIG. 5, which also include Middle Left (ML) and Middle Right (MR) loudspeakers 5230 and 5240.

In some embodiments, the non-height channels, e.g. the Front Left and Front Right channels and/or the Rear Left and Rear Right channels, are processed prior to be mixed with the corresponding virtual filtered portions of the height channels. For example, the Front Left and Front Right channels and/or the Rear Left and Rear Right channels, may be processed to compensate for the off-center listening position of the passenger(s)/driver in the vehicle. Compensation of the off-center listening position may be performed with the algorithm described in EP1994795B1, which is hereby incorporated by reference in its entirety. In EP1994795B1 it was shown that it is possible to ‘virtual center’ two listening positions symmetrically off-center from the same pair of (stereo) loudspeakers at the same time. This follows the same principle of reducing the phase differences of an interaural phase difference (IDP) of a single listening position. In case of two listening positions, the phase differences of the IDP obtained for each of the two listening positions are simultaneously reduced such that each IDP at each listening position has across the desired frequency range values between −90 and 90 degrees. By compensating for the off-center listening positions and mixing the filtered portions of the height channels with the corresponding compensated Front and/or Rear non-height channels, panning of the content of the portion of height channels across the Front and/or Rear loudspeakers may be prevented.

### Example Computing Device

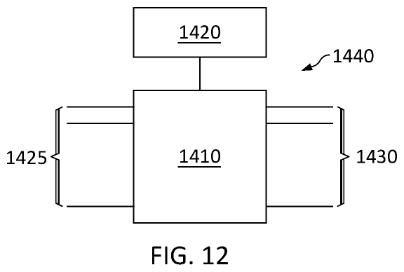

A method of generating a plurality of audio channels from audio in an immersive audio format for playing back the plurality of audio channels with an immersive loudspeaker system comprising at least one height loudspeaker and a plurality of front and rear non-height loudspeakers has been described. Additionally, the present disclosure also relates to an apparatus for carrying out these methods. Furthermore, the present disclosure relates to a vehicle which may comprise an apparatus for carrying out these methods. An example of such apparatus 1440 is schematically illustrated in FIG. 12. The apparatus 1440 may comprise a processor 1410 (e.g., a central processing unit (CPU), a graphics processing unit (GPU), a digital signal processor (DSP), one or more application specific integrated circuits (ASICs), one or more radio-frequency integrated circuits (RFICs), or any combination of these) and a memory 1420 coupled to the processor 1410. Memory 1420 may for example store an (or a set of) analytical function(s) or a (or a set of) look up table(s) representing the one or more parameters identifying the filter transfer function of the virtual height filter, e.g. for different listening positions and/or elevations of the roof and/or different vehicles. The processor may be configured to carry out some or all of the steps of the methods described throughout the disclosure, e.g. by retrieving the set of analytical functions and/or LTUs from memory 1420. To carry out the method of generating the the plurality of audio channels, the apparatus 1440 may receive, as inputs, channels of (e.g. rendered) audio in an immersive audio format, e.g. an height channel and one or more front or surround audio channels 1425. In this case, apparatus 1440 may output two or more channel signals 1430 for playback of the channel signals in an immersive loudspeaker system.

The apparatus 1440 may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that apparatus. Further, while only a single apparatus 1440 is illustrated in FIG. 12, the present disclosure shall relate to any collection of apparatus that individually or jointly execute instructions to perform any one or more of the methodologies discussed herein.

The present disclosure further relates to a program (e.g., computer program) comprising instructions that, when executed by a processor, cause the processor to carry out some or all of the steps of the methods described herein.

Yet further, the present disclosure relates to a computer-readable (or machine-readable) storage medium storing the aforementioned program. Here, the term “computer-readable storage medium” includes, but is not limited to, data repositories in the form of solid-state memories, optical media, and magnetic media, for example.

Embodiments described herein may be implemented in hardware, software, firmware and combinations thereof. For example, embodiments may be implemented on a system comprising electronic circuitry and components, such a computer system. Examples of computer systems include desktop computer systems, portable computer systems (e.g. laptops), handheld devices (e.g. smartphones or tablets) and networking devices. Systems for implementing the embodiments may for example comprise at least one of an integrated circuit (IC), a programmable logic device (PLD) such as a field programmable gate array (FPGA), a digital signal processor (DSP), an application specific IC (ASIC), a central processing unit (CPU), and a graphics processing unit (GPU).

Certain implementations of embodiments described herein may comprise a computer program product comprising instructions which, when executed by a data processing system, cause the data processing system to perform a method of any of the embodiments described herein. The computer program product may comprise a non-transitory medium storing said instructions, e.g. physical media such as magnetic data storage media including floppy diskettes and hard disk drives, optical data storage media including CD ROMs and DVDs, and electronic data storage media including ROMs, flash memory such as flash RAM or a USB flash drive. In another example, the computer program product comprises a data stream comprising said instructions, or a file comprising said instructions stored in a distributed computing system, e.g. in one or more data centers.

The present disclosure is not restricted to the embodiments and examples described above. Numerous modifications and variations can be made without departing from the scope of the present disclosure, defined by the accompanying claims.

Various aspects of the present invention may be appreciated from the following enumerated example embodiments (A-EEEs and B-EEEs):

A-EEE1. A method of generating discrete channels from an immersive bitstream, comprising
identifying one or more height channels and one or more non-height channels of the immersive bitstream,
processing the one or more height channels using a virtual height filter and a non-standard mixing technique, and
mixing the processed one or more height channels with the one or more non-height channels.

B-EEE 1. A method (1000) of generating at least two audio channels from audio in an immersive audio format comprising at least one height audio channel (1010) and at least two non-height audio channels (1050, 1100), for playing back the at least two audio channels with a non-immersive loudspeaker system of at least two audio loudspeakers (1,2) inside a vehicle, the method comprising:
applying (1500) a virtual height filter (1300) to the at least one height channel (1010) for, when the at least one audio height channel is played back by one of the at least two loudspeakers, at least partially attenuating spectral components of the at least one height channel (1010) directly emanating from said loudspeaker (1,2) and for at least partially amplifying spectral components of the at least one height channel reflected from a roof or an area close to the roof inside the vehicle, to generate at least one virtual height filtered audio signal (1175),
mixing (1700) the at least one virtual height filtered audio signal (1175) with at least one of the two non-height audio channels to generate the at least two audio channels (1008, 1016).

B-EEE 2. The method (1000) of B-EEE 1, wherein the audio in the immersive audio format further comprises at least two further non-height audio channels (1125,1150) and wherein the virtual height filtered audio signal (1175) is mixed with each one of the non-height audio channels (1050, 1100, 1125, 1150) to generate four audio channels (1008, 1016, 1032, 1064).

B-EEE 3. The method of any of the previous B-EEEs, wherein the audio in the immersive audio format comprises at least two height audio channels (1010,1020), and wherein the virtual height filter (1300, 1400) is applied to each one of the at least two height audio channels (1010, 1020) to generate at least two virtual height filtered audio signal (1175, 1200) and wherein each one of the virtual height filtered audio signals (1175, 1200) is mixed with one of the at least two non-height channels (1100, 1050).

B-EEE 4. The method of any one of the previous B-EEEs, wherein the audio in the immersive audio format comprises four height audio channels (1010,1020, 1030, 1040) and four non-height audio channels (1050, 1100, 1125, 1150), and wherein the virtual height filter (1300, 1400, 2500, 2600) is applied to each one of the four height audio channels (1010, 1020, 1030, 1040) to generate four virtual height filtered audio signals (1175, 1200, 1225, 1250) and wherein each one of the virtual height filtered audio signals (1175, 1200, 1225, 1250) is mixed with one of the four non-height channels (1100, 1050, 1125, 1150).

B-EEE 5. The method of any one of the previous B-EEEs, wherein the non-immersive loudspeaker system is a stereo or surround loudspeaker system.

B-EEE 6. The method of any one of the previous B-EEEs, wherein the virtual height filter has a filter transfer function and wherein the method further comprises determining the filter transfer function of the virtual height filter from one or more parameters identifying the filter transfer function.

B-EEE 7. The method of any one of the previous B-EEEs, wherein the virtual height filter has a filter transfer function having a peak at a first frequency and a notch at a second frequency higher than the first frequency.

B-EEE 8. The method of B-EEEs 6 and 7, wherein the one or more parameters are indicative of at least one value of: a peak, a first frequency, a notch, and a second frequency of the filter transfer function.

B-EEE 9. The method of any one of the previous B-EEEs, wherein the at least two audio loudspeakers (1,2) are laterally spaced with respect to a listening position.

B-EEE 10. The method of B-EEE 9, further comprising determining (1800) a filter transfer function for the virtual height filter based on a relative distance of the at the least two loudspeakers from the listening position and on an elevation of the roof or area close to the roof relative to the listening position.

B-EEE 11. The method of B-EEE 9, further comprising obtaining (1900) a plurality of filter transfer functions for a plurality of virtual height filters based on a range of relative distances of the at the least two loudspeakers from the listening position and on a range of elevations of the roof or area close to the roof relative to the listening position and selecting (2000) one filter transfer function from the plurality of filter transfer functions.

B-EEE 12. The method of claim 11, wherein the selected filter transfer function is the average of the plurality of filter transfer functions.

B-EEE 13. The method of claim 11 as far dependent on any of the claim 6 to 8, wherein selecting one filter transfer function from the plurality of filter transfer functions comprises selecting one or more parameters identifying the selected filter transfer function based on an average distance of the at the least two loudspeakers from the listening position and based on an average elevation of the roof or area close to the roof relative to the listening position.

B-EEE 14. The method of any of the B-EEEs 11 to 13, wherein the steps obtaining (1900), selecting (2000), applying (1500) and mixing (1700) are iteratively applied for each selected filter transfer function until the filter transfer function provides a playback of the at least two channels with maximum perception of sound elevation.

B-EEE 15. The method of any one of the B-EEEs 6 to 14, further comprising storing the one or more parameters in a processor as a look-up table or as an analytical function.

B-EEE 16. The method of any one of the preceding B-EEEs, further comprising applying a gain to the virtual height filter.

B-EEE 17. The method of B-EEE16, wherein the gain is user configurable.

B-EEE 18. The method of any one of the previous B-EEEs, wherein the audio in the immersive audio format is audio rendered in the immersive audio format and/or wherein the immersive audio format is Dolby Atmos, or any X.Y.Z audio format where X≥2 is the number of front or surround audio channels, Y≥0 is, when present, a Low Frequency Effects or subwoofer audio channel, and Z≥1 is the at least one height audio channel.

B-EEE 19. An apparatus configured to perform the method of any of B-EEEs 1-18.

B-EEE 20. A vehicle including a loudspeaker system of at least two audio loudspeakers (1,2), further comprising the apparatus of B-EEE 19.

B-EEE 21. A program comprising instructions that, when executed by a processor, cause the processor to carry out the method according to any one of the B-EEEs 1-18.

B-EEE 22. A computer-readable storage medium storing the program according to B-EEE 21.

1. A method of generating a plurality of audio channels from audio in an immersive audio format comprising a plurality of front and rear height audio channels and a plurality of front and rear non-height audio channels, for playing back the plurality of audio channels inside a listening environment with an immersive loudspeaker system comprising at least one height loudspeaker and a plurality of front and rear non-height loudspeakers, the method comprising:
applying a virtual height filter to a portion of each front and rear height audio channel of the plurality of front and rear height audio channels for, when one of the front and rear height audio channels is played back by a corresponding loudspeaker of the plurality of front and rear non-height loudspeakers, at least partially attenuating spectral components of said one height audio channel directly emanating from said non-height loudspeaker and for at least partially amplifying spectral components of said one height audio channel reflected from a roof or an area close to the roof inside the listening environment, to generate a plurality of front and rear virtual height filtered audio signals;
adding each front and rear virtual height filtered audio signal of the plurality of front and rear virtual height filtered audio signals to the corresponding front and rear non-height audio channel of the plurality of front and rear non-height audio channels, to generate added audio signals for playback by the corresponding front and rear non-height loudspeaker; and
playing back the remaining portion of each front and rear height audio channel of the plurality of front and rear height channels with the at least one height loudspeaker.

2. The method of claim 1, wherein the portion of each front and rear height audio channel of the plurality of front and rear height channels is a function of one or more of: a location of the at least one height loudspeaker along a length of the listening environment or a desired balance distribution of the plurality of front and rear height audio channels among the loudspeakers of the immersive loudspeaker system.

3. The method of claim 2, wherein the portion of each front and rear height audio channel is a linear or non-linear function of the location of the at least one height loudspeaker along the length of the listening environment.

4. The method of claim 1, wherein applying the virtual height filter to a portion of each front and rear height audio channel of the plurality of front and rear height audio channels comprises applying the virtual height filter to a portion of the front height audio channels which is proportional to a location of the at least one height loudspeaker moving away from the front and getting close to the rear of the listening environment.

5. The method of claim 1, wherein applying the virtual height filter to a portion of each front and rear height audio channel of the plurality of front and rear height audio channels comprises applying the virtual height filter to a portion of the rear height audio channels which is proportional to a location of the at least one height loudspeaker moving away from the rear and getting close to the front of the listening environment.

6. The method of claim 1, wherein playing back the remaining portion of each front and rear height audio channel of the plurality of front and rear height audio channels with the at least one height loudspeaker comprises playing back a remaining portion of each front height audio channel which is proportional to a location of the at least one height loudspeaker moving away from the rear and getting close to the front of the listening environment.

7. The method of claim 1, wherein playing back the remaining portion of each front and rear height audio channel of the plurality of front and rear height audio channels with the at least one height loudspeaker comprises playing back a remaining portion of each rear height audio channel which is proportional to a location of the at least one height loudspeaker moving away from the front and getting close to the rear of the listening environment.

8. The method of claim 1, wherein the audio in an immersive audio format further comprises a front right and a front left non-height audio channels, a rear right and a rear left non-height audio channels, a top front right and a top front left height audio channels and a top rear right and a top rear left height audio channels, wherein the front virtual height filtered audio signals are added to the corresponding front right and front left non-height audio channels and the rear virtual height filtered audio signals are added to the corresponding rear right and rear left non-height audio channels to generate four added audio signals for playback by corresponding front right and front left, and rear right and rear left non-height loudspeakers.

9. The method of claim 1, wherein the immersive loudspeaker system includes a single top loudspeaker without including additional top loudspeakers.

10. The method of claim 8, wherein the remaining portions of the top front right height audio channel, top rear right height audio channel, top front left height audio channel and top rear left height audio channel are summed up together and playback by the single top loudspeaker.

11. The method of claim 1, wherein the immersive loudspeaker system comprises a top right height loudspeaker and top left height loudspeaker.

12. The method of claim 11, wherein the remaining portions of the top front right height audio channel and top rear right height audio channel are summed up together and played back by top right height loudspeaker and the remaining portions of the top front left height audio channel and top rear left height audio channel are summed up together and played back by the top left height loudspeaker.

13. The method of claim 1, wherein the virtual height filter has a filter transfer function and wherein the method further comprises determining the filter transfer function of the virtual height filter from one or more parameters identifying the filter transfer function.

14. The method of claim 1, wherein the virtual height filter has a filter transfer function having a peak at a first frequency and a notch at a second frequency higher than the first frequency.

15. The method of claim 13, wherein the one or more parameters are indicative of at least one value of: a peak, a first frequency, a notch, and a second frequency of the filter transfer function.

16. The method of claim 1, wherein the at least two of the front and/or rear non-height loudspeakers are laterally spaced with respect to a listening position, and wherein the method further comprises determining a filter transfer function for the virtual height filter based on a relative distance of the at the least two loudspeakers from the listening position and on an elevation of the roof or area close to the roof relative to the listening position.

17. The method of claim 1, wherein at least two of the front and rear non-height loudspeakers are laterally spaced with respect to a listening position, and wherein the method further comprises:
obtaining a plurality of filter transfer functions for a plurality of virtual height filters based on a range of relative distances of said two loudspeakers from the listening position and on a range of elevations of the roof or area close to the roof relative to the listening position; and
selecting one filter transfer function from the plurality of filter transfer functions.

18. (canceled)

19. The method of claim 17, wherein the steps obtaining, selecting, applying, adding and playing back are iteratively applied for each selected filter transfer function until the filter transfer function provides a playback of the generated plurality of audio channels with maximum perception of sound elevation.

20. (canceled)

21. The method of claim 1, further comprising applying a gain or user-configurable gain to the virtual height filter.

22. The method of claim 1, wherein the audio in an immersive audio format is audio rendered in the immersive audio format and/or wherein the immersive audio format is Dolby Atmos, or any X.Y.Z audio format where X≥2 is the number of front or surround audio channels, Y≥0 is, when present, a Low Frequency Effects or subwoofer audio channel, and Z>1 is the plurality of front and rear height audio channels.

23. (canceled)

24. An apparatus comprising a processor and a memory storing one or more programs including instructions for performing the method of claim 1.

25. The apparatus of claim 24, wherein the apparatus is a vehicle including an immersive loudspeaker system comprising at least one height loudspeaker and a plurality of front and rear non-height loudspeakers.

26. A non-transitory computer-readable storage medium storing one ore more programs including instructions that, when executed by a processor, cause the processor to carry out the method according to claim 1.

27. (canceled)
